(19) United States
(12) Patent Application Publication
(10) Pub. No.: US 2009/0274539 A1
(43) Pub. Date: Nov. 5, 2009

(54) Load sweep

(76) Inventor: Jared Elliott Bockoff, Torrance, CA (US)

Correspondence Address: Jared Elliott Bockoff, 1732 Cabrillo Avenue #D, Torrance, CA, 90501, US

(21) Appl. No.: 12/151,127

(22) Filed: May 5, 2008

(51) Int. Cl. B65G 67/04; B65G 69/00

(52) U.S. Cl. 414/400; 224/310; 414/402

(57) ABSTRACT

The invention is a tool used for aiding in the removal of material from the forks of a forklift to the overhead rack system of a pickup truck.

After a forklift loaded with material lowers its forks onto a truck's overhead rack system, the forklift draws away, forcing the material against the Load Sweep. This force is transferred through the Load Sweep into the stationary overhead rack system attached to the vehicle. The forks then withdraw, allowing the material to drop onto the overhead rack system.

### BACKGROUND OF INVENTION

The field of endeavor for this invention is to aid in the removal of material from a standard forklift onto a standard pick-up truck's overhead rack system.

### BRIEF SUMMARY OF INVENTION

The “Load Sweep” is designed to speed the process of material transfer between forklift and pick-up truck. Currently, many overhead rack systems provided in the marketplace do not provide a convenient means to aid in the transfer of materials from a forklift to a pick-up truck's overhead rack system. This invention provides an economical & convenient solution to the time delay in the transfer of materials between said vehicles and their corresponding components.

### BRIEF DESCRIPTION OF THE DRAWINGS

FIG. 1—The upper of two horizontally parallel rails of an overhead rack system. This rail supports the Load Sweep and provides a point of pivot for the Load Sweep to transfer forces to the lower rail, FIG. 2.

FIG. 2—The lower of two horizontally parallel rails of an overhead rack system that's to remain static, counteracting the forces placed upon it by the material delivery through the Load Sweep.

FIG. 3—A rigid leg, offset from rigid leg, FIG. 4. Rigid leg, FIG. 3, is to extend upwards beyond the upper rail, FIG. 1, so as to provide sufficient backing for the intended load to be stopped as forks are drawn away.

FIG. 4—A rigid leg that extends below the lower rail, FIG. 2 (typically at an angle sufficient to allow the leg to clear the lower rail FIG. 2). The distance the leg, FIG. 4, extends below the lower rail, FIG. 2, shall be sufficient for an individual to grab hold of with one hand. To be used as a handle and also function as a counterweight.

FIG. 5—An offsetting connection. This is a rigid connection between leg, FIG. 3, & leg, FIG. 4. This connection firmly holds the legs, FIG. 3 & FIG. 4, parallel or angled slightly, tapering towards the upper rail, FIG. 1.

### DETAILED DESCRIPTION OF THE PREFERRED EMBODIMENT

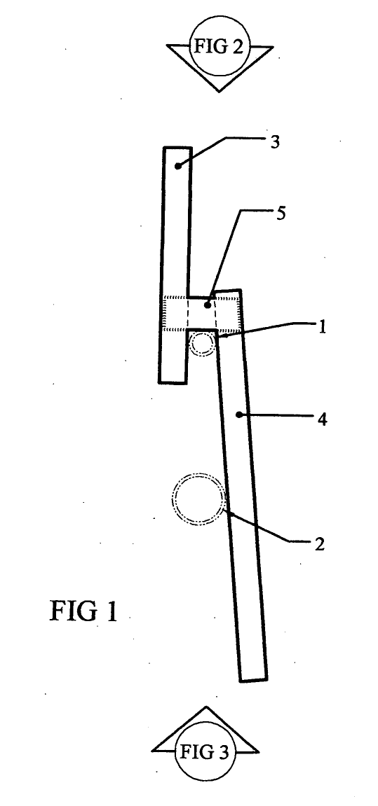

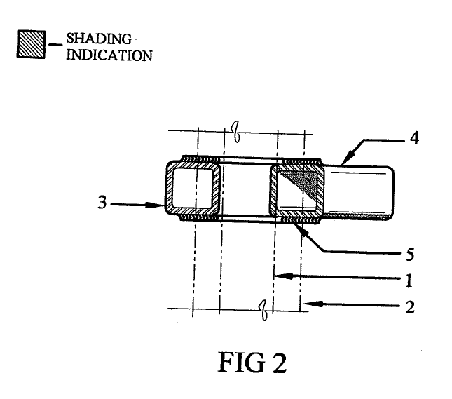

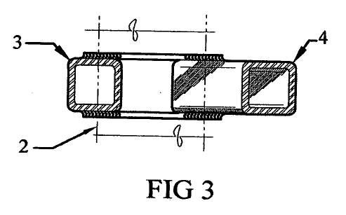

The “Load Sweep” is designed to be hung on the top of two (horizontally) parallel rails of a pickup truck's overhead steel rack system. After the “Load sweep” or “Load Sweeps” have been placed, a forklift may position a load of materials beyond the “Load Sweep(s)”, and over the truck's rack system from one side of the vehicle by raising its forks (along with the load that rests upon the forks) up and over the “Load Sweep(s)”. The forklift may then lower its load to the lowest possible position with the forks then resting on top of the upper rail of said rack system. The forklift may then pull away from the vehicle. As the forklift pulls away the load is forced against a rigid leg, FIG. 3. This force is transferred around the upper rail, FIG. 1, rotationally through a rigid connection, FIG. 5, into another leg, FIG. 4, and then into the static lower rail, FIG. 2. The rail, FIG. 2, remains (relatively) static due to its rigid connection to the vehicle onto which the load is being placed. This transfer of forces thus allows the forks to draw back, leaving the materials to drop upon the cross bars that brace the rails, FIG. 1 & FIG. 2, perpendicularly on the overhead rack system.

The claim of this document is the invention of the “Load Sweep” and the functioning of the corresponding components as described herein:

1. Functions of the Load Sweep include the following:
1) The manner in which forces are utilized to aid in the task of material transfer.
2) The handle as counterweight, allowing the device to maintain an upright position.
The main components are 2 rigid legs offset by a rigid connection.
The components transfer forces into a static member allowing the rapid transfer of loads from a standard forklift to a standard pick up truck overhead rack system.
